(19) United States
(12) Patent Application Publication
(10) Pub. No.: US 2022/0296047 A1
(43) Pub. Date: Sep. 22, 2022

(54) Bowl Divider Device

(71) Applicant: Nancy Forney, Berwyn Heights, MD (US)

(72) Inventor: Nancy Forney, Berwyn Heights, MD (US)

(21) Appl. No.: 17/680,547

(22) Filed: Feb. 25, 2022

Related U.S. Application Data
(60) Provisional application No. 63/161,662, filed on Mar. 16, 2021.

(51) Int. Cl. A47J 43/28

(52) U.S. Cl. CPC A47J 43/28

(57) ABSTRACT

The present invention relates generally to the field of dining utensils. More specifically, the present invention relates to a bowl divider device. The device is comprised of a body further comprised of at least one handle assembly that has at least one handle, at least one vertical stem and a plurality of panels that are removably or fixedly attached to the vertical stem. Once the panels are attached to the stem, the device can be placed within a bowl such that spaces between each panel are formed. Within each space, a user can add differing ingredients to make a salad or other food. In this manner, the bowl divider device prevents a salad or other food from looking boring and uninspiring.

### CROSS-REFERENCE TO RELATED APPLICATION

The present application claims priority to, and the benefit of, U.S. Provisional Application No. 63/161,662 which was filed on Mar. 16, 2021 and is incorporated herein by reference in its entirety.

### FIELD OF THE INVENTION

The present invention relates generally to the field of dining utensils. More specifically, the present invention relates to a bowl divider device. The device is comprised of a body further comprised of at least one handle assembly that has at least one handle, at least one vertical stem, and a plurality of panels that are removably or fixedly attached to the vertical stem. Once the panels are attached to the stem, the device can be placed within a bowl such that spaces between each panel are formed. Within each space, a user can add differing ingredients to make a salad or other food. In this manner, the bowl divider device prevents a salad or other food from looking boring and uninspiring. Accordingly, the present disclosure makes specific reference thereto. Nonetheless, it is to be appreciated that aspects of the present invention are also equally applicable to other like applications, devices and methods of manufacture.

### BACKGROUND

Salads are an incredibly healthy food that may contain a plurality of ingredients such as fruits, vegetables, nuts, cheeses, meats, dressings, etc. As a result, some individuals may desire to eat healthier and consume salads to do so. However, some individuals may find salads to be boring looking and therefore uninspiring. Further, salads are typically mixed together in a bowl before being consumed. This mixed appearance may be visually unappealing to some individuals.

Therefore, there exists a long-felt need in the art for a device that prevents a salad or other food from looking boring and uninspiring. There also exists a long-felt need in the art for a bowl divider device that can be placed within a bowl that allows a salad or other food to be presented using the device in a more visually appealing manner. Further, there exists a long-felt need in the art for a bowl divider device that can be placed within a bowl that allows a salad or other food to be presented using the device in a more visually appealing manner, wherein the device does not allow the various ingredients of the salad or other food to become mixed.

The subject matter disclosed and claimed herein, in one embodiment thereof, comprises a bowl divider device. The device is comprised of a body further comprised of at least one handle assembly that has at least one handle, at least one vertical stem and a plurality of panels that are removably or fixedly attached to the vertical stem. Once the panels are attached to the stem, the device can be placed within a bowl such that spaces between each panel are formed. Within each space, a user can add differing ingredients to make a salad or other food.

In this manner, the bowl divider device of the present invention accomplishes all of the forgoing objectives and provides a device that prevents a salad or other food from looking boring and uninspiring. The device also allows a salad to be presented using the device in a more visually appealing manner, wherein the device does not allow the various ingredients of the salad or food to become mixed. Therefore, the device allows users to create salads or foods in a more visually appealing manner than possible without the device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bowl divider device. The device is comprised of a body further comprised of at least one handle assembly that has at least one handle, at least one vertical stem and a plurality of panels that are removably or fixedly attached to the vertical stem. In the one embodiment the body is manufactured from a silicone-type rubber material or a flexible, semi-rigid or rigid plastic. Further, any surface of the body may have a plurality of indicia such as, but not limited to, patterns, logos, emblems, images, symbols, designs, letters, words, characters, animals, advertisements, brands, etc. The body may also be any color known in the art and may be transparent, semi-transparent or opaque.

The handle assembly is comprised of at least one handle. The handle preferably has a contoured and textured grip that may be made of the same rubber or plastic material described above. The handle further has a continuous opening such that it can be easily gripped by a user. In differing embodiments, the handle may be removably or fixedly (e.g. inseparably) attached to the vertical stem. In one embodiment, the handle and vertical stem may each have at least one fastener that allows for the stem and handle to removably or fixedly attach to one another. In the preferred embodiment, the stem is further comprised of at least two vertical female grooves.

The device is also comprised of at least two panels that are preferably shaped like one-fourth (e.g. a quadrant) of a circle and have a curved outside edge, a vertical inside edge that is parallel with the stem and a flat top edge. The inside edge of each panel is further comprised of a male tongue that can be slid into each groove of the stem to allow the panels to be removably attached to the stem. Although, in one embodiment, the panels may be fixedly (e.g. inseparably) attached to the stem. In another embodiment, the panels may attach to the stem via at least one fastener that allows the panels to removably attach to the stem.

To use the device, the device can be placed within a bowl such that the outside edge of each panel contacts the interior surface of the bowl. In doing so, the panels form spaces within the bowl that can be filled with various differing ingredients. After being filled, the device can be lifted vertically out of the bowl via the handle such that the ingredients remain separated in the manner they were when the device remained in place within the bowl.

Accordingly, the bowl divider device of the present invention is particularly advantageous as it provides a device that prevents a salad or other food from looking boring and uninspiring. The device also allows a salad or food to be presented using the device in a more visually appealing manner, wherein the device does not allow the various ingredients of the salad to become mixed. In this manner, the bowl divider device allows users to create salads or foods in a more visually appealing manner than possible without the device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bowl divider device of the present invention in accordance with the disclosed architecture;

FIG. 2A illustrates an exploded side view of one potential embodiment of a bowl divider device of the present invention in accordance with the disclosed architecture;

FIG. 2B illustrates an exploded side view of one potential embodiment of a bowl divider device of the present invention in accordance with the disclosed architecture;

FIG. 3 illustrates a perspective view of one potential embodiment of a bowl divider device of the present invention within a bowl in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that prevents a salad or other food from looking boring and uninspiring. There also exists a long-felt need in the art for a bowl divider device that can be placed within a bowl that allows a salad or other food to be presented using the device in a more visually appealing manner. Further, there exists a long-felt need in the art for a bowl divider device that can be placed within a bowl that allows a salad or other food to be presented using the device in a more visually appealing manner, wherein the device does not allow the various ingredients of the salad or other food to become mixed.

The present invention, in one exemplary embodiment, is comprised of a bowl divider device comprised of a body that is further comprised of at least one handle assembly. The at least one handle assembly has at least one handle, at least one vertical stem, and a plurality of panels that are removably or fixedly attached to the vertical stem. In the one embodiment the body is manufactured from a silicone-type rubber material or a flexible, semi-rigid or rigid plastic. Further, any surface of the body may have a plurality of indicia such as, but not limited to, patterns, logos, emblems, images, symbols, designs, letters, words, characters, animals, advertisements, brands, etc. The body may also be any color known in the art and may be transparent, semi-transparent or opaque.

The handle assembly is comprised of at least one handle that preferably has a contoured and textured grip that may be made of the same rubber or plastic material described above. The handle further has a continuous opening such that it can be easily gripped by a user. In differing embodiments, the handle may be removably or fixedly (e.g. inseparably) attached to the vertical stem. In one embodiment, the handle and vertical stem may each have at least one fastener that allows for the stem and handle to removably or fixedly attach to one another. In the preferred embodiment, the stem is further comprised of at least two vertical female grooves.

The device is also comprised of at least two panels that are preferably shaped like one-fourth (e.g. a quadrant) of a circle and have a curved outside edge, a vertical inside edge that is parallel with the stem and a flat top edge. Accordingly, the inside edge of each panel is further comprised of a male tongue that can be slid into each groove of the stem to allow the panels to be removably attached to the stem. Although, in one embodiment, the panels may be fixedly (e.g. inseparably) attached to the stem. In another embodiment, the panels may attach to the stem via at least one fastener that allows the panels to removably attach to the stem.

During use, the device can be placed within a bowl such that the outside edge of each panel contacts the interior surface of the bowl. In doing so, the panels form spaces within the bowl that can be filled with various differing ingredients. After being filled, the device can be lifted vertically out of the bowl via the handle such that the ingredients remain separated in the manner they were when the device remained in place within the bowl.

Accordingly, the bowl divider device of the present invention is particularly advantageous as it provides a device that prevents a salad or other food from looking boring and uninspiring. The device also allows a salad or food to be presented using the device in a more visually appealing manner, wherein the device does not allow the various ingredients of the salad to become mixed. In this manner, the bowl divider device allows users to create salads or foods in a more visually appealing manner than possible without the device.

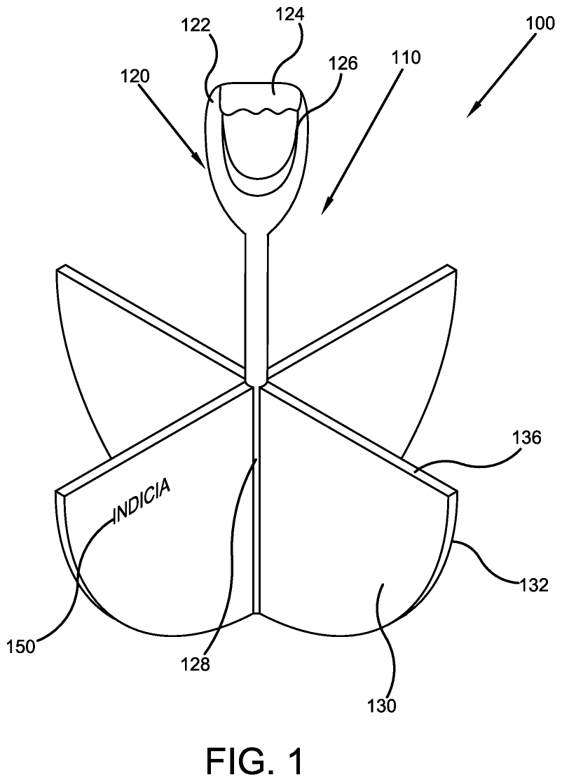

Referring initially to the drawings, FIG. 1 illustrates a perspective view of one potential embodiment of a bowl divider device 100 of the present invention in accordance with the disclosed architecture. The device 100 is comprised of a body 110 further comprised of at least one handle assembly 120 that has at least one handle 122, at least one vertical stem 128 having a longitudinal axis or centerline and a plurality of panels 130 that are removably or fixedly attached to the vertical stem 128. In the one embodiment the body 110 is manufactured from a silicone-type rubber material that may be flexible, semi-rigid or rigid in differing embodiments. Said rubber material may also include materials such as, but not limited to, neoprene, nitrile, EPDM, Styrene-Butadiene, Butyl, natural, fluorosilicone, etc. In another embodiment, the body 110 is manufactured from a flexible, semi-rigid, or rigid plastic such as, but not limited to, an acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. Further, any surface of the body 110 may have a plurality of indicia 150 such as, but not limited to, patterns, logos, emblems, images, symbols, designs, letters, words, characters, animals, advertisements, brands, etc. The body 110 may also be any color known in the art and may be transparent, semi-transparent or opaque.

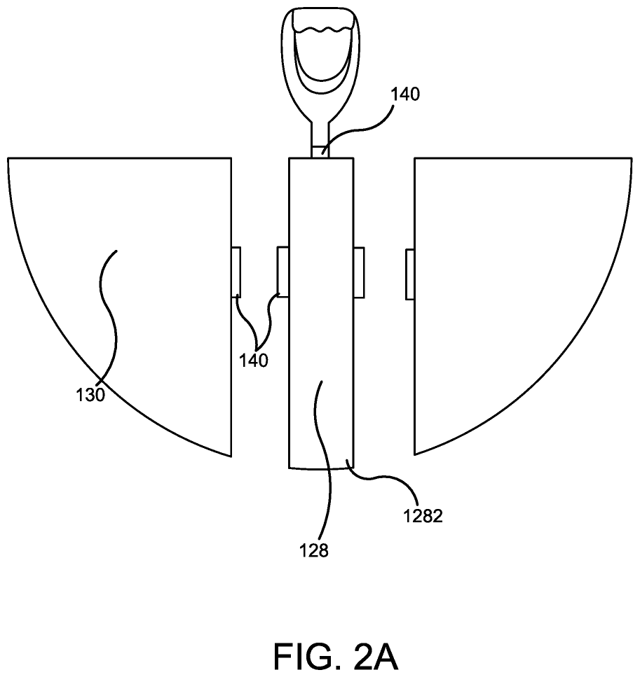

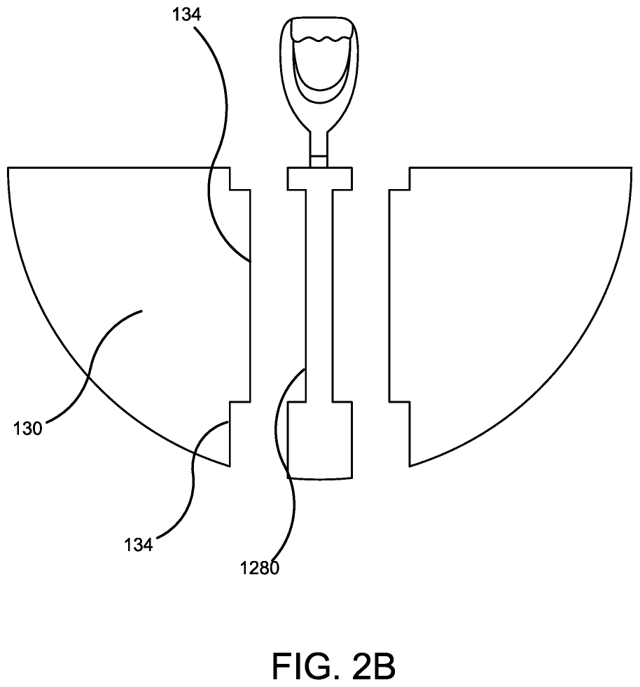

The handle assembly 120 is comprised of at least one handle 122 that may be further comprised of a contoured and textured grip 124 that may be made of the same rubber or plastic material described above. The handle 122 further has a continuous opening 126 such that it can be easily gripped by a user. The handle 122 is further removably or fixedly (e.g. inseparably) attached to the vertical stem 128. In one embodiment, the handle 122 and vertical stem 128 may each have at least one fastener 140 such as, but not limited to, hook and loop, magnet, adhesive, screws, threading, etc., that allows for the stem 128 and handle 122 to removably or fixedly attach to one another, as seen in FIG. 2A. Similarly, the stem 128 may be comprised of at least two fasteners 140 that allow at least two panels 130 to removably connect to the vertical stem 128 via at least one fastener 140 on each panel 130 (such that the entire stem 128 has at least three fasteners). In the preferred embodiment, the stem 128 is further comprised of at least two vertical female grooves 1280. The stem 128 may also have a curved bottom surface 1282.

FIG. 2B illustrates an exploded side view of one potential embodiment of a bowl divider device 100 of the present invention in accordance with the disclosed architecture. The device 100 is also comprised of at least two panels 130. The panels 130 are preferably shaped like one-fourth (e.g. a quadrant) of a circle and have a curved outside edge 132, a vertical inside edge 134 that is parallel with the stem 128 and a flat top edge 136. The inside edge 134 of each panel 130 is further comprised of a male tongue 1340. The tongue 1340 can then be slid into each groove 1280 of the stem 128 to allow the panels 130 to be removably attached to the stem 128. In one embodiment, the panels 130 may be fixedly (e.g. inseparably) attached to the stem 128. In another embodiment, the panels 130 may attached to the stem 128 via an at least one fastener 140 such as, but not limited to, a hook and loop fastener, magnet, adhesive, screws, threading, etc., that allows the panels 130 to removably attach to the stem 128.

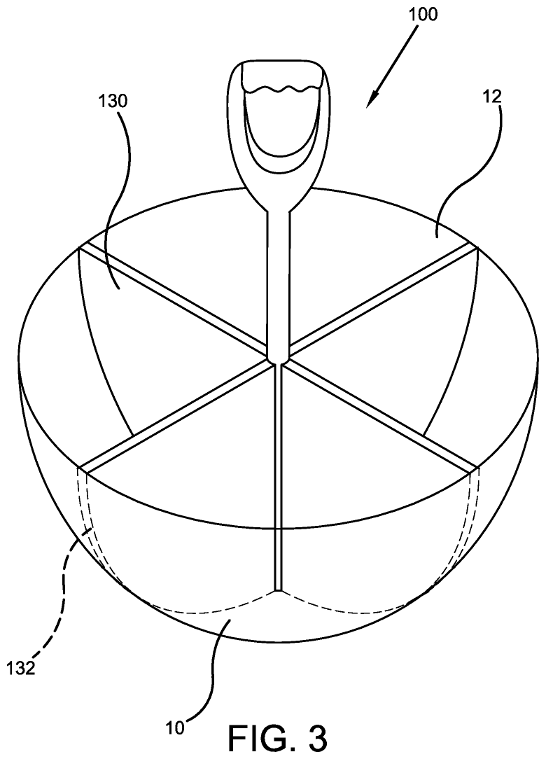

FIG. 3 illustrates a perspective view of one potential embodiment of a bowl divider device 100 of the present invention within a bowl 10 (shown as prior art) in accordance with the disclosed architecture. To use the device 100, the device 100 can be placed within a bowl 10 such that the outside edge 132 of each panel 130 contacts the interior surface 12 of the bowl 10. As a result, the panels 130 form spaces within the bowl 10 that can be filled with various differing ingredients. After being filled, the device 100 can be lifted vertically out of the bowl 10 via the handle 122, such that the ingredients remain separated in the manner they were when the device 100 remained in place within the bowl 10. In should be noted that in differing embodiments, the device 100 can be used to separate any ingredients of any food in this manner to create a more visually appealing food/dish, and is not limited only to salads or other similar foods of the like.

It should also be noted that in any embodiment, the stem 128 can have a number of differing grooves 1280 and panels 130, but preferably has at least two grooves 1280 and at least two panels 130. However, the panels 130 and grooves 1280 may be located at any angle in relation to one another and as a result may create equal or unequal spaces within a bowl 10. In this manner, the number of panels 130 and spaces created by the panels 130 within a bowl 10 can be customized per the needs of each individual user in differing embodiments of the device 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bowl divider device” and “device” are interchangeable and refer to the bowl divider device 100 of the present invention.

Notwithstanding the forgoing, the bowl divider device 100 of the present invention and its various components can be of any suitable size and configuration as is known in the art without affecting the overall concept of the invention, provided that they accomplish the above-stated objectives. One of ordinary skill in the art will appreciate that the size, configuration and material of the bowl divider device 100 as shown in the FIGS. are for illustrative purposes only, and that many other sizes and shapes of the bowl divider device 100 are well within the scope of the present disclosure. Although the dimensions of the bowl divider device 100 are important design parameters for user convenience, the bowl divider device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bowl divider device comprising:
a handle assembly comprised of a handle and a vertical stem; and
at least two panels.

2. The bowl divider device of claim 1, wherein the at least two panels are fixedly attached to the vertical stem.

3. The bowl divider device of claim 2, wherein each of the at least two panels are shaped like a quadrant of a circle.

4. The bowl divider device of claim 1, wherein the handle is further comprised of a grip and a continuous opening.

5. A bowl divider device comprising:
at least two panels, wherein the at least two panels are each further comprised of a curved outside edge, a vertical inside edge having a male tongue, and a flat top edge; and
a handle assembly comprised of a handle having a grip and a continuous opening, and a vertical stem fixedly attached to the handle, wherein the vertical stem is further comprised of at least two female grooves.

6. The bowl divider device of claim 5, wherein the inside vertical edge of each of the at least two panels is substantially parallel with a longitudinal axis of the vertical stem.

7. The bowl divider device of claim 6, wherein the male tongue of the at least two panels allows the at least two panels to removably attach to the at least two female grooves of the vertical stem.

8. The bowl divider device of claim 7, wherein the at least two panels are shaped like a quadrant of a circle.

9. The bowl divider device of claim 5, wherein the grip is contoured and textured.

10. The bowl divider device of claim 5, wherein a bottom surface of the vertical stem is curved.

11. A bowl divider device comprising:
at least two panels, wherein the at least two panels are each further comprised of a curved outside edge, a vertical inside edge having at least one fastener, and a flat top edge; and
a handle assembly comprising:
a handle having at least one fastener, a grip, and a continuous opening; and
a vertical stem attached to the handle, wherein the vertical stem is comprised of at least one fastener that attaches to the at least one fastener of the handle and at least two fasteners that attach to each of the at least one fastener of the vertical inside edge of the at least two panels.

12. The bowl divider device of claim 11, wherein each of the at least one fastener of the at least two panels are a select one of a hook and loop fastener, a magnet fastener, an adhesive fastener, a screw fastener and a threaded fastener.

13. The bowl divider device of claim 11, wherein the at least two fasteners of the vertical stem that attach to each of the at least one fastener of the vertical inside edge of the at least two panels is a select one of a hook and loop fastener, a magnet fastener, an adhesive fastener, a screw fastener and a threaded fastener.

14. The bowl divider device of claim 11, wherein the at least one fastener of the handle is a hook and loop fastener, a magnet fastener, an adhesive fastener, a screw fastener or a threaded fastener.

15. The bowl divider device of claim 11, wherein the at least one fastener of the vertical stem that attaches to the at least one fastener of the handle is a select one of a hook and loop fastener, a magnet fastener, an adhesive fastener, a screw fastener and a threaded fastener.

16. The bowl divider device of claim 11, wherein the bowl divider device is manufactured from a rigid plastic material.

17. The bowl divider device of claim 11, wherein the grip is contoured and textured.

18. The bowl divider device of claim 11, wherein a bottom surface of the vertical stem is curved.

19. The bowl divider device of claim 11, wherein the inside edge of each of the at least two panels is substantially parallel with a longitudinal axis of the vertical stem.

20. The bowl divider device of claim 11, wherein the at least two panels are shaped like a quadrant of a circle.
